(19) United States
(12) Patent Application Publication
(10) Pub. No.: US 2015/0138992 A1
(43) Pub. Date: May 21, 2015

(54) BASE STATION ANTENNA BEAM FORMING BASED JAMMING DETECTION AND MITIGATION

(71) Applicant: AT&T Intellectual Property I, L.P., Atlanta, GA (US)

(72) Inventor: Roger Piqueras Jover, New York, NY (US)

(73) Assignee: AT&T Intellectual Property I, L.P., Atlanta, GA (US)

(21) Appl. No.: 14/081,926

(22) Filed: Nov. 15, 2013

(51) Int. Cl. H04K 3/00; H04W 24/04

(52) U.S. Cl. CPC H04K 3/224; H04W 24/04; H04K 2203/16
USPC 370/244

(57) ABSTRACT

A method, computer-readable storage device and apparatus for locating a source of a communication impairment are disclosed. For example, the method detects the communication impairment at a base station, performs a sweep to locate a direction of the source of the communication impairment, wherein the sweep is performed in response to the detecting the communication impairment at the base station, and generates a null in the direction of the source of the communication impairment.

Embodiments of the present disclosure relate to detecting jamming attacks on a base station and techniques to minimize the effects of such jamming attacks.

### BACKGROUND

Long Term Evolution (LTE) offers enhanced capacity and coverage for current mobility networks, which experience a constant traffic increase and skyrocketing bandwidth demands. LTE is built upon a redesigned physical layer and based on an Orthogonal Frequency Division Multiple Access (OFDMA) modulation. LTE also features robust performance in challenging multipath environments and improves the performance of the wireless channel in terms of bits per second per Hertz (bps/Hz). Nevertheless, LTE remains vulnerable to radio jamming attacks.

### SUMMARY

In one embodiment, the present disclosure describes a method, computer readable storage device and apparatus for locating a source of a communication impairment. For example, the method detects the communication impairment at a base station, performs a sweep to locate a direction of the source of the communication impairment, wherein the sweep is performed in response to the detecting the communication impairment at the base station, and generates a null in the direction of the source of the communication impairment.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2A illustrates an exemplary jamming attack on a base station sector;

FIG. 2B illustrates an exemplary smart jamming attack on a base station sector;

FIG. 3A illustrates a base station sector during a sweep to detect a source of a communication impairment, according to embodiments of the present disclosure;

FIG. 3B illustrates a radiation beam pattern, or gain pattern, of a base station sector during a sector sweep to detect a source of a communication impairment, according to embodiments of the present disclosure;

FIG. 3C illustrates a base station sector while directing a null in the direction of a source of a communication impairment, according to embodiments of the present disclosure;

FIG. 3D illustrates a radiation beam pattern, or gain pattern, of a base station sector while directing a null in the direction of a source of a communication impairment, according to embodiments of the present disclosure;

FIG. 4 illustrates a flowchart of a method for locating a source of a communication impairment at a base station, according to embodiments of the present disclosure; and

FIG. 5 illustrates a high-level block diagram of a general-purpose computer suitable for use in performing the functions, methods and algorithms described herein.

To facilitate understanding, identical reference numerals have been used, where possible, to designate identical elements that are common to the figures.

### DETAILED DESCRIPTION

The present disclosure broadly describes a method, computer-readable storage device and apparatus for locating a source of a communication impairment at a base station. Although the present disclosure is discussed below in the context of exemplary LTE networks and evolved uniform terrestrial radio access networks (eUTRANs), the present disclosure is not so limited. Namely, the present disclosure can be applied to communication networks in general, e.g., general packet radio service (GPRS) networks, uniform terrestrial radio access networks (UTRANs), Global System for Mobile Communications (GSM) networks, and the like, where at least one cellular access network is available.

In one embodiment, the present disclosure describes a technique for detection and mitigation of jamming attacks on a base station. Jamming attacks generally involve transmitting radio signals to disrupt communications between cell sites and mobile devices and to decrease the signal-to-noise ratio. For an LTE base station, or eNodeB, this can cause LTE communications to fall back to GSM mode, which is less secure and allows a number of exploits to be used to intercept traffic, steal credentials, and so forth. In particular the GSM encryption is weaker than the LTE standards. In addition, a successful jamming attack on LTE communications does not necessarily need high power, and can be focused on essential LTE control channels if these are known, e.g., saturating a paging channel.

To address these issues, in one embodiment the base station employs multiple antennas for each sector, providing spatial diversity. For example, each base station typically has three sectors, with each sector employing a plurality of antennas (e.g., three antennas, five antennas and so forth). When the base station detects an impairment condition, e.g., a low signal-to-noise ratio, or some other trigger, the base station may initiate a process to detect a direction/location of a source of the communication impairment. In particular, the base station considers that the communication impairment is due to a jamming signal and attempts to locate the source of the jamming signal.

In one embodiment, the base station may control the azimuthal angles and/or vertical tilt of the antenna radiation beam pattern of a sector to form a narrow beam and then sweep the beam across the 120 degrees of the sector (or a different range, if the sector is other than 120 degrees). In one embodiment, when the strongest interfering signal is detected or the lowest signal-to-noise ratio (SNR) is detected, the base station determines that this is the likely direction and/or general location of the jamming signal. Thereafter, the base station may then control the multiple antennas of the sector to form a null (e.g., an approximately 50-60 dB or greater loss) in the direction of the detected jamming signal. The null being a portion of the antenna radiation pattern where a direction correlating to the detected jamming signal is strongly attenuated. This will mitigate the interference of the jamming signal and allow communications between the base station and legitimate mobile devices to continue, e.g., without falling back to GSM.

To further aid in understanding, the following provides a brief overview of common terms and technologies related to the present disclosure. Broadly defined, 3GPP is a global effort to define a wireless communication system specification. 2G refers to a second generation cellular network technology, 3G refers to a third generation cellular network technology, and 4G is a fourth generation cellular network technology. GSM is an example of a 2G cellular technology and a Universal Mobile Telecommunications System (UMTS) is an example of a 3G cellular network technology. In accordance to the 3GPP global effort, a General Packet Radio Service (GPRS) refers to a communications service used to transfer data via a cellular network. GPRS is available to users of a 2G cellular system, e.g., GSM. The GPRS provides an enhancement to the GSM system so that data packets are supported. In addition, in 3GPP release 8, LTE is provided as a set of enhancements to the UMTS. The enhancement focuses on adopting 4th Generation (4G) mobile communications technology to include an all Internet Protocol (IP) end-to-end networking architecture. LTE is an example of a 4G cellular network technology.

A base station for a 2G network is also referred to as a base transceiver station (BTS). A base station in a 3G network is also referred to as a Node B. At a particular time period, a particular base station in a 3G wireless network is controlled by a radio network controller (RNC). If at a later time period, another radio network controller is selected to control the traffic traversing through the particular base station, the particular base station is said to be re-homed to the later radio network controller. Similarly, at a particular time period, each base station in a 2G wireless network is controlled by a base station controller (BSC). For a 4G network, a radio base transceiver station (RBS), as per the 3GPP standards, is referred to as an eNodeB (or simply as a base station). An eNodeB for a 4G network provides an LTE-air interface and performs radio resource management for wireless access. It should be noted base stations in accordance with other network protocols or standards are within the scope of the present disclosure.

The radio network controllers and base station controllers route calls from user endpoint devices towards their destination via the service provider's core network. Similarly, calls destined to the user endpoint devices traverse the core network to reach a radio network controller (for 3G), a base station controller (for 2G) or an eNodeB (for 4G). As applicable, the radio network controllers, base station controllers and eNodeBs forward the calls towards their intended user endpoint device.

In one embodiment, a base station for a wireless network may be deployed with one or more sets of directional antennas that cover a predetermined portion of the 360 degree angle. A portion of a wireless network that is covered with one set of directional antennas is referred to as a sector. For example, if there are three sets of directional antennas at a base station, each set of directional antennas covers 120 degrees, thereby resulting in three sectors. The exemplary base station may also be referred to as a three sector base station. In general, the coverage of a sector is 360 degrees divided by the number of sectors of the base station. However, other configurations are possible, e.g., where some sectors have greater coverage than others.

In one embodiment, e.g., in a 2G/GSM network, each sector uses a predetermined portion of available frequency resources such that adjacent sectors may assign channels in mutually exclusive frequency ranges. However, it should be noted that other cellular networks may assign frequency ranges in a different manner and the present disclosure is not limited in this aspect. For example, each of the three sectors above may use one third of available frequency resources. Adjacent sectors use different frequency ranges. The channels for adjacent sectors are then assigned in mutually exclusive frequency ranges such that interference is minimized. However, in another embodiment, e.g., in a code division multiple access (CDMA) network or in an orthogonal frequency division multiple access (OFDMA) network (e.g., a 4G/LTE network), each cell and each sector may utilize all of the available frequency resources. In other words each cell and/or each sector reuses the same frequency resources.

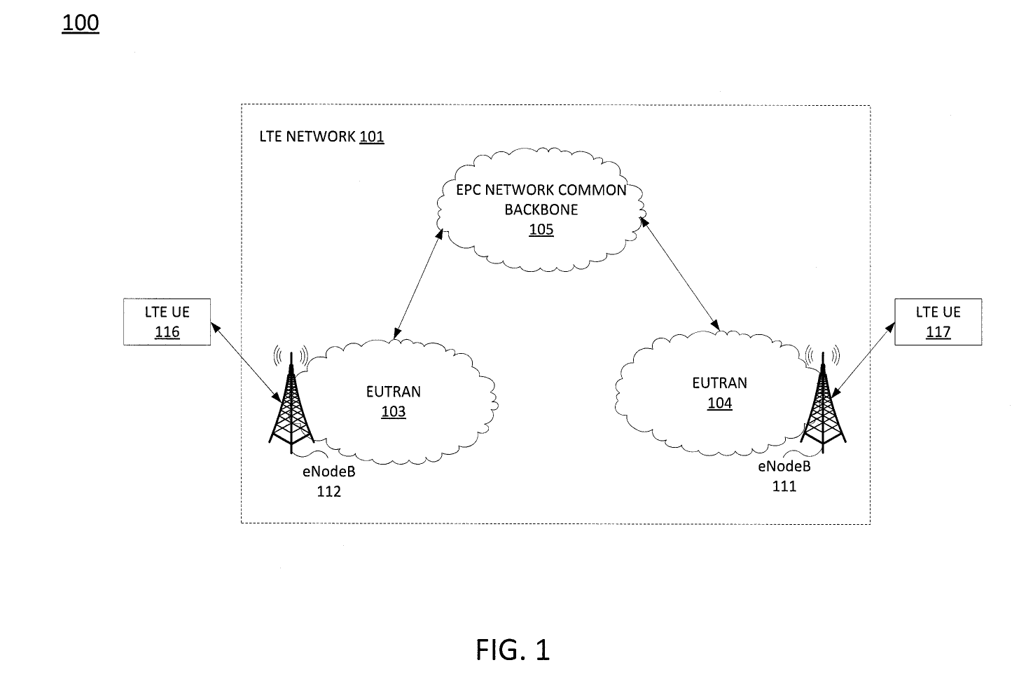

FIG. 1 illustrates an exemplary network 100 related to the present disclosure. In one illustrative embodiment, the network 100 comprises an LTE network 101 and user endpoint devices 116 and 117.

The user endpoint devices 116 and 117 can be a smart phone, a cellular phone, a computer or laptop, a computing tablet, or any endpoint communication devices equipped with wireless capabilities.

The LTE network 101 may comprise access networks 103 and 104 and a core network 105. In one example, each of the access networks 103 and 104 comprises an evolved Universal Terrestrial Radio Access Network (eUTRAN). In one example, the core network 105 comprises an Evolved Packet Core (EPC) network.

The eUTRANs are the air interfaces of the 3GPP's LTE specifications for mobile networks. Namely, the eUTRAN comprises a radio access network standard that will replace previous generations of air interface standards. All eNodeBs in the eUTRANs 103 and 104 are in communication with the EPC network 105. The EPC network provides various functions that support wireless services in the LTE environment. In one embodiment, an EPC network is an Internet Protocol (IP) packet core network that supports both real-time and non-real-time service delivery across a LTE network, e.g., as specified by the 3GPP standards.

In operation, LTE user equipment or user endpoint (UE) 116 may access wireless services via the eNodeB 112 located in the eUTRAN 103. Similarly, the LTE UE 117 may access wireless services via the eNodeB 111 located in the eUTRAN 104. It should be noted that any number of eNodeBs can be deployed in an eUTRAN. In one illustrative example, the eUTRANs 103 and 104 may comprise one or more eNodeBs.

The above network 100 is described to provide an illustrative environment in which embodiments of the present disclosure may be employed. In other words, the network 100 is merely illustrative of one network configuration that is suitable for implementing embodiments of the present disclosure. Thus, the present disclosure may also include any other different network configurations that are suitable for implementing embodiments of the present disclosure, for conveying communications among endpoint devices, for conveying communications between endpoint devices and other components (e.g., core network and access network components), and so forth. Those skilled in the art will realize that the communication system 100 may be expanded by including additional endpoint devices, access networks, network elements, application servers, etc., or modifying or substituting those illustrated in FIG. 1, without altering the scope of the present disclosure.

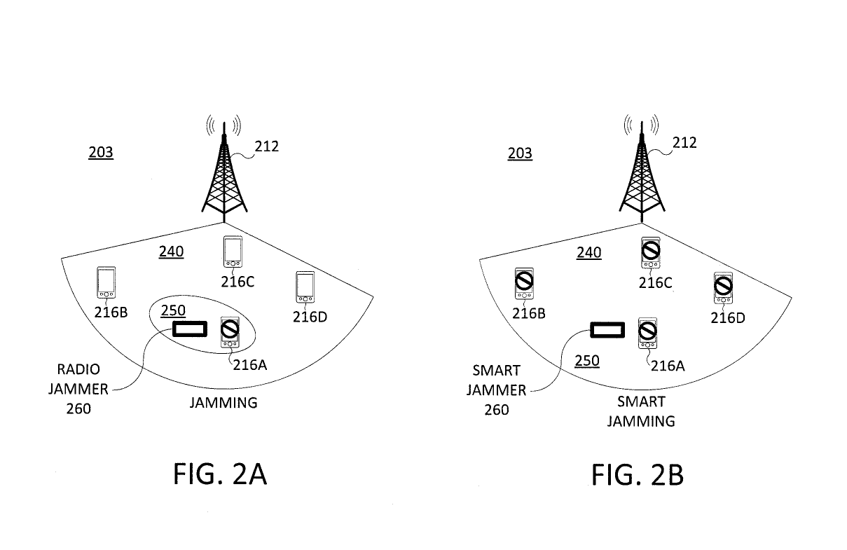

To further aid in understanding the present disclosure, FIG. 2A illustrates a conventional jamming attack on a base station sector 240 of a cell 203. As illustrated in FIG. 2A, cell 203 comprises a base station 212 that is servicing endpoint devices 216A-216D in sector 240. In one embodiment, base station 212 comprises an eNodeB of an eUTRAN (e.g., a 4G network), or a NodeB of a UTRAN (e.g., a 3G network). As also illustrated in FIG. 2A, a radio jammer 260 is transmitting a jamming signal that covers an area 250. Notably, in a traditional jamming attack, the radio jammer transmits a jamming signal, typically random noise, over a broad range of frequencies to attempt to disrupt communication. However, to jam the entire frequency band often requires a considerable amount of power. Consequently, if radio jammer 260 comprises a typical endpoint device, such as a cellular phone, cellular-enabled laptop computer or an off-the-shelf radio jammer, the radio jammer 260 may only be capable of jamming a small area 250 surrounding the radio jammer 260. In this example, endpoint device 216A is within area 250 and thus is jammed by the signal from radio jammer 260. In one example, the jamming causes the signal-to-noise ratio (SNR), the signal-to-interference-and-noise (SINR) ratio and/or the received signal strength indication (RSSI) experienced by endpoint device 216A (and any other device in the area 250 affected by the jamming) to drop. Alternatively or in addition, the jamming may cause the bit-error rate (BER) experienced by endpoint device 216A to increase. In another embodiment, the jamming may cause a drop in traffic volume from a base station to be observed in a core network, while the base station still appears to be operational.

As a further consequence, as noted above jamming may cause 4G/LTE or 3 G communications to deteriorate to the point where an endpoint device and/or base station may fall back on to 2G/GSM communications. Thus, in this example, endpoint device 216A may attempt to communicate with the base station 212 via GSM during the jamming attack. For example, the base station 212 may include components to support legacy GSM communications as a backup, or as an alternative to 3G, 4G and/or LTE. However, GSM communications are widely considered to have weak encryption standards and are subject to known exploits for base station spoofing, sniffing attacks, phishing attacks and so forth. In this regard, it should be noted that even if the base station 212 does not support 2G/GSM communication, an attacker may set up a femtocell or 2G base station (e.g., a base transceiver station (BTS)) that appears to be a legitimate base station from the perspective of the endpoint device 216A. For example the attacker may use the same device, e.g., radio jammer 260, for radio jamming as well as for providing a rouge base station. If the endpoint device 216A can be forced or tricked into connecting to the rouge base station, the attacker can then implement a number of further exploits. It should be noted that several examples herein describe attacks on 3G and/or 4G/LTE base stations, where 2G/GSM components comprise a backup infrastructure. Nevertheless, the present disclosure may also be applied to attacks on cellular base stations that employ various different types of technology, including 2G/GSM infrastructure. In particular, the present disclosure relates to any base station with multiple directional antennas which can be controlled for beam steering and null generation.

FIG. 2B illustrates a more advanced jamming attack on a base station sector 240, referred to herein as “smart jamming”. In particular, the cell 203, base station 212, sector 240 and endpoint devices 216A-216D may comprise the same devices and areas shown in FIG. 2A. However, in this case the radio jammer 260 illustrated in FIG. 2B comprises a smart jammer. Notably, the radio jammer 260 concentrates the jamming signal and power output over one or more specific and targeted frequencies, or over a narrower range of frequencies as compared to the radio jammer 260 in FIG. 2A. Thus, in FIG. 2B, the area 250 affected by the jamming signal is much larger and may include the entire range of sector 240, e.g., when the attack targets uplink signaling channels. As such, all of endpoint devices 216A-216D are affected. For example, a typical endpoint device, such as a cellular telephone or laptop computer, may be capable of jamming both uplink and downlink control channels used for 3G/LTE call establishment and maintenance using off-the-shelf components or with only small upgrades or enhancements to the radio resources, e.g., an amplifier, range extender and so forth. For example, a smart jamming attack may target the physical broadcast channel (PBCH) which has assigned physical resource blocks (PRBs) which are known in advance and are always mapped to the central 72 subcarriers of the OFDMA signal. Similarly, a smart jamming attack may target the physical downlink control channel (PDCH or PDCCH), the physical uplink control channel (PUCH or PUCCH), the physical random access channel (PRACH), the primary synchronization signal (PSS), the secondary synchronization signal (SSS) and so forth.

It should be noted that LTE includes physical channels as well as logical channels, and that control channels may be physical control channels or logical control channels. The most straightforward smart jamming attack will target the physical control channels occupying defined frequencies/wavelengths. However, logical control channels may also be targeted if the attacker knows the timing of the logical control channel. For example, some of the control channels may comprise slot assignments within a master information block (MIB), e.g., on a central 72 subcarriers of the spectrum. Thus, the smart jamming may target the 72 central subcarriers with a noise signal synchronized to the timing of the particular control channel's slot assignments. However, it also remains possible for an attacker to simply target the central 72 subcarriers with a continuous noise signal.

In any case, by targeting specific channels/frequencies used for conveying signaling information for call establishment, the radio jammer 260 can effectively disrupt all communications. A successful smart jamming attack allows the attacker to utilize all of the same exploits available with regular (broadband) jamming, but affords a greater range. In addition, the cell tower itself may be affected while allowing the radio jammer 260 to be located a safe distance away, e.g., where the attacker can remain concealed or anonymous, if the attacker is using, for example, a directional antenna pointed to the eNodeB. In other words, the attacker may effectively locate the radio jammer 260 anywhere in the sector 240, while being able to affect all or most of the endpoint devices in the sector 240 as well as the equipment of base station 212 that services the sector 240.

To mitigate jamming attacks such as illustrated in FIGS. 2A and 2B, the present disclosure includes a process for sweeping a sector to locate a jamming source and then directing a null in the detected direction. Notably, a large percentage of currently deployed cell towers/base stations already include multiple antennas per sector (e.g., typically three). Advanced LTE developments also indicate that five antennas per sector will become commonplace. However, the multiplicity of antennas is presently used to improve the performance of the physical layer, e.g., in terms of bit error rate (BER) and minimum received power (spatial diversity). For instance, endpoint devices are rarely equipped with more than one antenna. Therefore, spatial diversity is typically not possible in the downlink. However, cellular networks are not limited in the downlink since transmission power at the base station can be increased to reach the design requirements. On the other hand, a smart-phone or mobile terminal is limited in the amount of power its transceiver can output as well as the battery life. Therefore, it is beneficial to implement spatial diversity in the uplink, leading to the current use of three antennas per sector. Similarly, the use of multiple antennas for LTE advanced has been proposed, but for purposes of forming multiple parallel beams to further enhance spatial multiplexing of endpoint devices. In contrast, the present disclosure utilizes multiple antennas to perform adaptive beam-forming in order to detect and to block an interference/jamming signal.

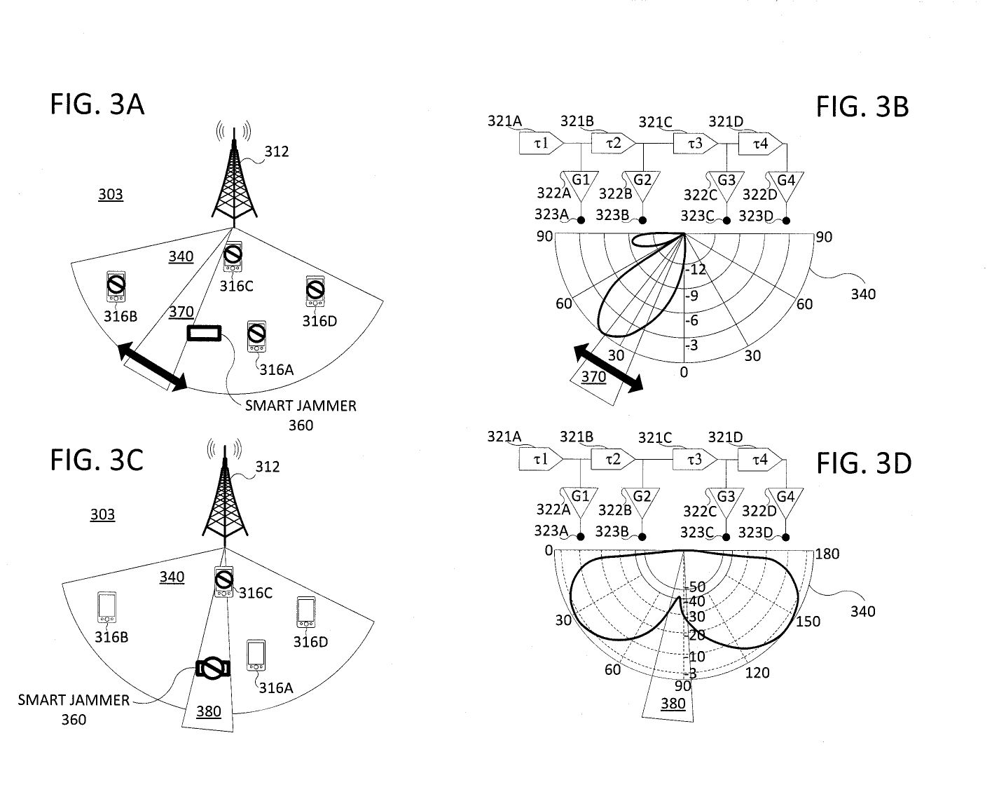

In accordance with the present disclosure, FIG. 3A illustrates an example of sweeping a sector to locate a source of a communication impairment. As illustrated in FIG. 3A, cell 303 comprises a base station 312 that is servicing endpoint devices 316A-316D in sector 340. In one embodiment, base station 312 comprise an eNodeB of a eUTRAN (e.g., a 4G network), or a NodeB of a UTRAN (e.g., a 3G network). However, in another embodiment, base station 312 comprises a 2G/GSM base station, or BTS. Notably, in one embodiment base station 312 includes a plurality of antennas for sector 340 (e.g., three antennas, four antennas, five antennas, and so forth). As also illustrated in FIG. 3A, a radio jammer 360 is transmitting a jamming signal that covers all or a significant portion of the sector 340. Notably, all of the endpoint devices 316A-316D are affected by the jamming signal.

In one embodiment, when a communication impairment that may be indicative of a jamming attack is detected, the base station 312 implements beam sweeping throughout a range of the affected sector 340. For example, a communication impairment may comprise a decreased signal-to-noise ratio (SNR), decreased signal-to-interference-and-noise (SINR) ratio, decreased received signal strength indication (RSSI) and/or an increased bit-error rate (BER) detected at the base station. The communication impairment may affect one or more frequencies and/or channels, or may affect an entire range of frequencies. In response to detecting such an impairment, the base station then creates a narrow beam 370 (also referred to herein as radiation pattern or a gain pattern) and steers/sweeps the beam across the sector. In one embodiment, the base station determines the direction of the source of the communication impairment (i.e., a jamming signal) when a greatest interference signal strength is detected during the sweep, when a lowest SNR, SINR or RSSI is experienced, when greatest bit-error rate is experienced, and so forth.

FIG. 3B illustrates in greater detail relevant components of the base station 312 for performing the beam sweep illustrated in FIG. 3A. In particular, base station 312 includes antennas 323A-323D dedicated to the sector 340. In one example, the antennas 323A-323D are arranged linearly. However, other configurations, e.g., along a conical curve, are possible in accordance with the present disclosure. Each antenna 323A-323D has a corresponding gain element 322A-322D for controlling the gain of the respective antenna. In addition, delay elements 321A-321D are for introducing successive delays to the antennas 323A-323D. By controlling the gain (amplitude) and delay (phase) of copies of the signal transmitted by the antennas 323A-323D using well known techniques, the base station 312 can create a directional beam 370.

An example of the gain pattern of the directional beam 370 is also shown in FIG. 3B. For example, the gain pattern shows a strong main lobe and smaller attenuated side lobes. The adjustment of gain and time delays may be used to similarly create a directional beam or gain pattern for received signals. Thus, the gain pattern shown in FIG. 3B is equally applicable to transmission signals as well as to reception signals. In addition, by adjusting the gain and delay parameters, the directional beam 370 can be steered throughout the range of sector 340 (e.g., 120 degrees, if three equal-sized sectors are implemented at base station 312). Accordingly, the base station 312 can record the direction in which the noise is the greatest and note this direction as the direction of the source of the communication impairment/source of a jamming signal. In this case, when the sweep of the beam 370 passes through the range of sector 340, the base station 312 may determine that the greatest noise signal (and/or lowest SNR, lowest SINR, and so forth) occurred when passing over radio jammer 360.

Once the direction of radio jammer 360 is determined, the base station 312 can implement mitigation measures. For example, as illustrated in FIG. 3C, the base station 312 may direct a null 380 in the direction of radio jammer 360. Notably, the null 380 may counteract the effect of the jamming signal from radio jammer 360 in all other areas of the sector 340. However, any endpoint devices in the same direction as the radio jammer 360 will also be prevented from communicating. As shown in FIG. 3C, endpoint device 316C is in the direction of the null 380 and is therefore prevented from communicating. However, the noise from the jamming signal that would affect uplink and downlink communications between the base station 312 and endpoint devices 316A, 316B and 316D have been significantly reduced.

FIG. 3D illustrates the corresponding gain pattern for the set of antennas 323A-323D when generating the null 380 in sector 340. Like the creation of the beam 370 illustrated in FIGS. 3A and 3B, the null 380 illustrated in FIGS. 3C and 3D may be formed by controlling the delay elements 321A-321D and the gain elements 322A-322D using well known techniques to adjust the radiation pattern/gain pattern of antennas 323A-323D. However, instead of creating a narrow beam, in this case, a broad pattern is created with a significant reduction in gain (a null) in a desired direction. For example, in one embodiment the null comprises an approximately 50-60 dB attenuation in the given direction, which may be sufficient to restore the SNR and/or SINR to an acceptable level, reduce the bit error rate, and so forth. In one embodiment, the null 380 is generated to have as narrow a range as possible to capture the radio jammer 360, while minimally affecting legitimate endpoint devices in other directions throughout the sector 340. However, the ability to scale the size, or width, of the null 380 may depend upon the number of antennas that are allocated to the sector.

It should be noted that in one embodiment, the detection of the communication impairment may occur at a device other than the base station 312. For example, an EPC network may detect a drop in traffic from the base station 312. Thus, the EPC network and/or a component thereof, may notify the base station 312. In turn, the base station 312 may sweep all sectors to determine whether a jamming signal is present and to determine a direction of the source of the jamming signal. In addition, although the foregoing describes the detection and mitigation of a malicious jamming signal, it should be noted that the present disclosure may also be used to mitigate interference from other sources. For example, a network operator typically seeks to place base stations in specific desirable locations, and configures the base stations to minimize interference. However, the network operator lacks the ability to control or predict when and where a user may deploy a device such as personal base station or femtocell. Therefore, personal base stations/femtocells comprise a potentially strong source of interference that can be detected and mitigated in the same manner as a malicious jamming signal.

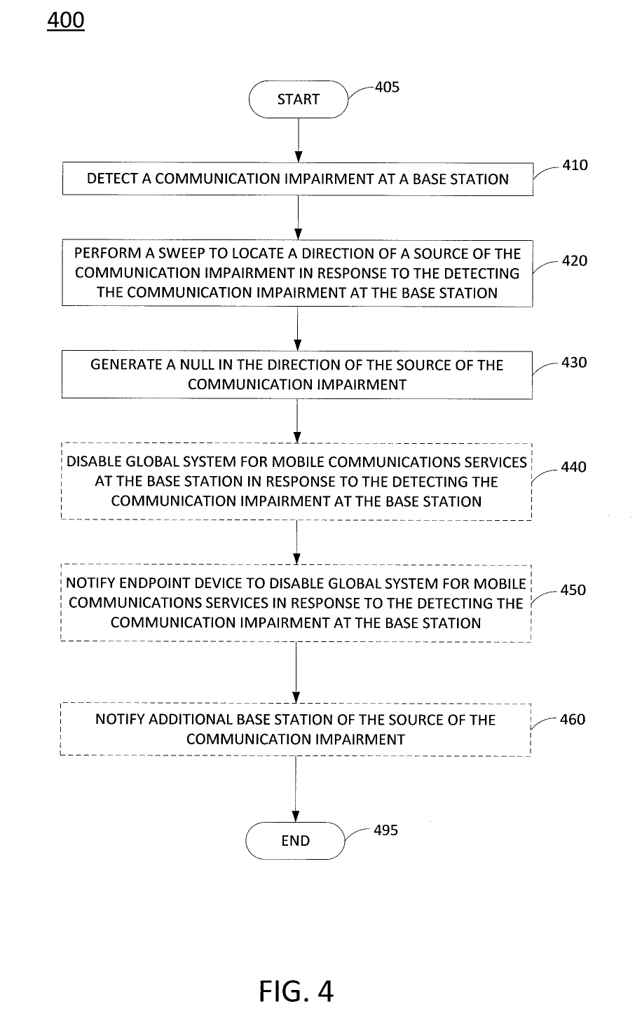

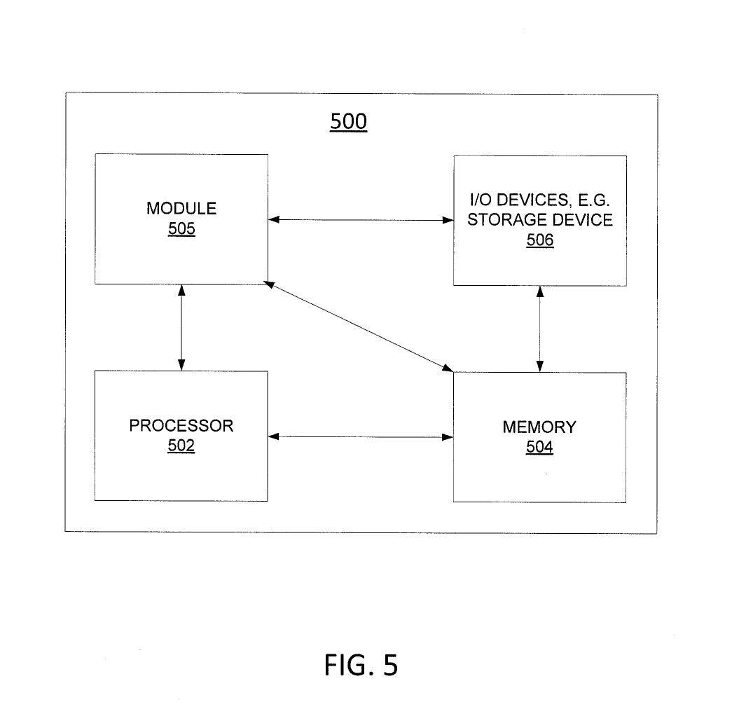

FIG. 4 illustrates a flowchart of a method 400 for locating a source of a communication impairment at a base station. In one embodiment, the method 400 is performed by a base station such as illustrated in any of FIGS. 1-3. Alternatively, or in addition, the steps, functions, or operations of method 400 may be performed by a computing device or system 500, and/or processor 502 as described in connection with FIG. 5 below.

Method 400 starts in step 405 and proceeds to step 410. In step 410, method 400 detects a communication impairment at a base station. For example, the method may determine that there is a drop in a signal-to-noise ratio (SNR), the signal-to-interference-and-noise (SINR) ratio and/or a received signal strength indication (RSSI) experienced at a base station. Alternatively or in addition, the method may determine that a bit-error rate (BER) has increased. In another embodiment, a core network may observe a drop in traffic volume from a base station, while the base station still appears to be operational. For example, an attacker may be jamming a primary synchronization signal, preventing endpoint devices from connecting with the base station. In turn, a drop in traffic from the base station may be observed in the core network. Thus, in this case, the method may receive a notification from the core network indicating the communication impairment.

In one embodiment, the method monitors all or a portion of the spectrum utilized by the base station for uplink and/or downlink communications. However, in another embodiment the method monitors one or more individual channels to detect the communication impairment on a particular channel. For example, the method may monitor the physical random access channel (PRACH) to observe a change in the SNR. Similarly, the method may separately monitor a plurality of other control channels in the same manner. In addition, in one embodiment the method 400 may employ a threshold for determining whether a communication impairment is detected. For example, the method may detect a communication impairment when the SNR decreases 20 percent or greater, when the BER increases beyond one percent, when the traffic volume declines 50 percent or greater, and so forth.

At step 420, the method 400 performs a sweep to locate a direction of the source of the communication impairment that is detected at step 410. In one embodiment, the method may detect the communication impairment at a particular sector of a base station. Thus, the method may perform the sweep only at the affected sector. However, it is possible that the communication impairment is not attributable to any particular sector following step 410. Therefore, in another embodiment the method may perform a sweep through each sector of a base station. Notably, the method may control a plurality of antennas assigned to a sector to form a directional beam and sweep the beam across the sector. For example, if the base station comprises three 120 degree sectors, the method may sweep the beam across the 120 degrees of a particular sector by controlling the radiation/gain pattern for the antennas assigned to the sector. In one embodiment, the direction of the source of the communication impairment is determined to be the direction in which a lowest SNR, SINR, or RSSI is experienced. In another embodiment, the direction of the source of the communication impairment is determined to be the direction in which a greatest bit-error rate is experienced. In one embodiment, where the communication impairment is detected on a specific channel (e.g., a specific control channel), the sweep may involve monitoring the SNR, SINR, RSSI, bit-error rate and the like with respect to the specific channel.

At step 430, the method 400 generates a null in the direction of the source of the communication impairment. For example, as mentioned above, a null may be formed by controlling the delays and the gains of different antennas assigned to a sector to adjust an overall radiation pattern/gain pattern of the set of antennas. For instance, a wide pattern may be created with a significant reduction in gain (a null) in the direction of the source of the communication impairment. In one embodiment, the null comprises an approximately 50-60 dB attenuation in the given direction, which may be sufficient to restore the SNR, SINR, RSSI, bit-error rate and the like to acceptable level(s). In one embodiment, the null is generated to have as narrow a range as possible to capture the source of the communication impairment, while minimally affecting legitimate endpoint devices in other directions throughout the sector. However, the ability to scale the size, or width, of the null may depend upon the number of antennas that are allocated to the sector.

At optional step 440, the method 400 may also disable GSM services as the base station in response to detecting the communication impairment. For instance, the source of the communication impairment may be a device of an attacker that is carrying out a denial-of-service attack on 3G and/or 4G/LTE services. The purpose of the attack may be to force endpoint devices down to 2G/GSM backup services in order to carry out further exploits. Thus, in one embodiment, the method may suspend backup GSM services at the base station until the communication impairment can be resolved or until a malicious attack can be ruled out as a cause of the communication impairment.

At optional step 450, the method 400 may also notify one or more endpoint devices to disable GSM services and GSM components. For example, even if the method disables GSM services and equipment at the base station, an attacker may set up a rouge GSM base station to force or trick endpoint devices into connecting thereto. Once connected, the attacker may engage in various exploits. Thus, by attempting to notify endpoint devices at optional step 450, the method may disrupt an attack that may rely upon base station spoofing.

At optional step 460, the method 400 may also notify one or more additional base stations of the source of the communication impairment. For example, the method may notify other base stations of the type of communication impairment, the affected frequency or frequencies, the channel that is affected, the direction in which the source of the communication impairment is detected and so forth. By sharing this information, the method may assist nearby base stations in adjusting their own radiation/gain patterns to minimize the effects of any jamming signals or other interference caused by the source of the communication impairment.

Following any of steps 430-460, the method 400 proceeds to step 495 where the method ends.

In addition, although not specifically specified, one or more steps, functions or operations of the method 400 may include a storing, displaying and/or outputting step as required for a particular application. In other words, any data, records, fields, and/or intermediate results discussed in the method can be stored, displayed and/or outputted either on the device executing the method or to another device, as required for a particular application.

Furthermore, steps, blocks, functions or operations in FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the example embodiments of the present disclosure.

FIG. 5 depicts a high-level block diagram of a general-purpose computer suitable for use in performing the functions described herein. As depicted in FIG. 5, the system 500 comprises one or more hardware processor elements 502 (e.g., a central processing unit (CPU), a microprocessor, or a multi-core processor), a memory 504, e.g., random access memory (RAM) and/or read only memory (ROM), a module 505 for locating a source of a communication impairment at a base station, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 505 for locating a source of a communication impairment at a base station (e.g., a software program comprising computer-executable instructions) can be loaded into memory 504 and executed by hardware processor element 502 to implement the steps, functions or operations as discussed above in connection with the exemplary method 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for locating a source of a communication impairment at a base station (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for locating a source of a communication impairment, the method comprising:
detecting, by a processor, the communication impairment at a base station;
performing, by the processor, a sweep to locate a direction of the source of the communication impairment, wherein the sweep is performed in response to the detecting the communication impairment at the base station; and
generating, by the processor, a null in the direction of the source of the communication impairment.

2. The method of claim 1, wherein the communication impairment comprises a jamming signal.

3. The method of claim 1, wherein the communication impairment comprises an impairment on a base station uplink control channel.

4. The method of claim 1, wherein the communication impairment comprises an impairment on a base station downlink control channel.

5. The method of claim 1, wherein communication impairment is detected as one of:
a decreased signal to noise ratio, a decreased signal to interference and noise ratio, or an increased bit error rate.

6. The method of claim 1, wherein the direction of the source of the communication impairment is determined based upon a detection of a greatest noise signal in the direction of the source of the communication impairment.

7. The method of claim 1, wherein the base station comprises a plurality of sectors, wherein each sectors comprises a plurality of antennas.

8. The method of claim 1, wherein the sweep comprises steering a beam through a range of a sector of the base station.

9. The method of claim 8, wherein the steering the beam comprises adjusting a phase and a gain of each of a plurality of antennas of a sector of the base station.

10. The method of claim 1, wherein the null is generated by adjusting a phase and a gain of each of a plurality of antennas of a sector of the base station.

11. The method of claim 1, wherein the communication impairment comprises an impairment on a long term evolution control channel.

12. The method of claim 11, further comprising:
disabling a global system for mobile communications service at the base station in response to the detecting the communication impairment at the base station.

13. The method of claim 11, further comprising:
notifying an endpoint device to disable a global system for mobile communications service in response to the detecting the communication impairment at the base station.

14. The method of claim 1, wherein the sweep comprises an azimuthal sweep of a sector of the base station.

15. The method of claim 1, wherein the detecting the communication impairment at the base station comprises:
receiving a notification of a decline in a traffic volume by the base station from a core network.

16. The method of claim 1, wherein the processor comprises a processor of the base station.

17. The method of claim 1, wherein the base station comprises a NodeB.

18. The method of claim 1, wherein the base station comprises an eNodeB.

19. A computer-readable storage device storing instructions which, when executed by a processor, cause the processor to perform operations for locating a source of a communication impairment, the operations comprising:
detecting the communication impairment at a base station;
performing a sweep to locate a direction of the source of the communication impairment, wherein the sweep is performed in response to the detecting the communication impairment at the base station; and
generating a null in the direction of the source of the communication impairment.

20. An apparatus for locating a source of a communication impairment, the apparatus comprising:
a processor; and
a computer-readable storage device storing instructions which, when executed by the processor, cause the processor to perform operations, the operations comprising:
detecting the communication impairment at a base station;
performing a sweep to locate a direction of the source of the communication impairment, wherein the sweep is performed in response to the detecting the communication impairment at the base station; and
generating a null in the direction of the source of the communication impairment.
